(19) United States
(12) Patent Application Publication
(10) Pub. No.: US 2021/0150485 A1
(43) Pub. Date: May 20, 2021

(54) DYNAMIC DETERMINATION OF JOB REQUIREMENTS AND CANDIDATE ASSESSMENT

(71) Applicant: INTERNATIONAL BUSINESS MACHINES CORPORATION, Armonk, NY (US)

(72) Inventors: Partho Ghosh, Visakhapatnam (IN); Preetha Ghosh, Hyderabad (IN); Sri Harsha Varada, Vizianagaram (IN); Venkata Vara Prasad Karri, Visakhapatnam (IN)

(21) Appl. No.: 16/689,782

(22) Filed: Nov. 20, 2019

(51) Int. Cl. G06Q 10/10; G06Q 10/06; G06N 20/00; G06F 16/9535

(52) U.S. Cl. CPC G06Q 10/1053; G06Q 10/06393; G06F 16/9535; G06N 20/00; G06Q 10/06398

(57) ABSTRACT

Determining job requirements and assessing a job candidate can include generating a set of job requirements and ranking a job candidate based a comparison of attributes of the job candidate with corresponding job requirements. The set of job requirements can be generated and dynamically refined by searching networked systems and extracting data therefrom in response to specifications determined by natural language processing of user input.

### BACKGROUND

This disclosure relates to computer systems and data communication networks, and more particularly, to computer systems and data communication networks for determining job requirements and assessing job candidates.

Computer systems can provide an abundant source of information pertaining to jobs and job candidates. Data communications networks allow job seekers and hiring entities to more efficiently interact through the exchange of data regarding requirements for jobs and attributes of candidates for jobs.

### SUMMARY

In one or more embodiments, a method can include generating a dynamically refinable set of job requirements by searching a plurality of networked systems and extracting data therefrom based on comparing data contained in the networked systems to specifications determined by natural language processing of user input. The method also can include ranking a job candidate based on comparing attributes of the job candidate to corresponding job requirements contained in the dynamically refinable set of job requirements.

In one or more embodiments, a system includes a processor configured to initiate executable operations. The executable operations can include generating a dynamically refinable set of job requirements by searching a plurality of networked systems and extracting data therefrom based on comparing data contained in the networked systems to specifications determined by natural language processing of user input. The executable operations also can include ranking a job candidate based on comparing attributes of the job candidate to corresponding job requirements contained in the dynamically refinable set of job requirements.

In one or more embodiments, a computer program product includes a computer readable storage medium having program code stored thereon. The program code is executable by a processor to initiate executable operations. The executable operations can include generating a dynamically refinable set of job requirements by searching a plurality of networked systems and extracting data therefrom based on comparing data contained in the networked systems to specifications determined by natural language processing of user input. The executable operations also can include ranking a job candidate based on comparing attributes of the job candidate to corresponding job requirements contained in the dynamically refinable set of job requirements.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 depicts a system for determining job requirements and assessing job candidates according to an embodiment of the present invention.

FIG. 2 is a flowchart of a method of determining job requirements and assessing job candidates according to an embodiment of the present invention.

FIG. 3 depicts a cloud computing environment in which a system for determining job requirements and assessing job candidates can be implemented according to an embodiment of the present invention.

FIG. 4 depicts abstraction model layers of the cloud computing environment illustrated in FIG. 3 according to an embodiment of the present invention.

FIG. 5 depicts a cloud computing node in which a system for determining job requirements and assessing job candidates can be implemented according to an embodiment of the present invention.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to computer systems and data communication networks, and more particularly, to computer systems and data communication networks for determining job requirements and assessing job candidates.

The term “job,” as used herein, refers to the tasks that an individual will perform in a certain role within a group, team, or organization. The term can refer to the individual's role as a member of a team tasked with delivering a specific set of deliverables on a single project or as an employee or contractor of an organization. Correspondingly, the “requirements” of a job are the specific attributes that an individual should possess for performing in that role.

The methods, systems, and computer program products disclosed herein can generate a set of job requirements and rank a job candidate. One aspect of the methods, systems, and computer program products disclosed herein is the creation of a conversational framework in which user input can be supplied as natural spoken language. The natural language input can automatically invoke one or procedures that search networked systems and extract from one or more of the networked systems data that provides a basis for generating the set of job requirements. Within the conversational framework, the set of job requirements can be dynamically refined with additional natural language input.

Another aspect is the generation and refinement of the set of job requirements with minimal user input. Using machine learning, a classification model can be trained to invoke a procedure in response to a single statement, as for example one identifying an individual (e.g., current or former employee) such as “we need a candidate like Ms. Smith, our company's current chief engineer.” The statement invokes procedures to gather data such as Ms. Smith's education, credentials, skills, work history, and any other relevant data from one or more networked systems. Using the data as a standard, a set of job requirements can be constructed such that a preferred candidate would have the same or comparable education, credentials, skills, and work history.

Similarly, a single statement like “find a set of candidates for an upcoming project like last year's project X,” can invoke procedures to gather data such as the skill and experience of various individuals who worked on project X and what the role of each was. Based on the data, separate sets of job requirements for various members (e.g., team leader, lead designer, lead tester) of a team for the upcoming project can be automatically generated. Similar natural language input of general, broad, or even vague nature can be used to dynamically refine a set of job requirements.

One aspect of a system as disclosed herein is the conversion of a computer on which the system runs to convert the computer into a more efficient, faster operating machine. A user need not enter individual requirements sought for a job candidate or members on a team for an upcoming project. Instead, a simple statement such as the example statements above is sufficient to invoke procedures to create one or more sets of job requirements. A set of job requirements can be used to identify and rank job candidates.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

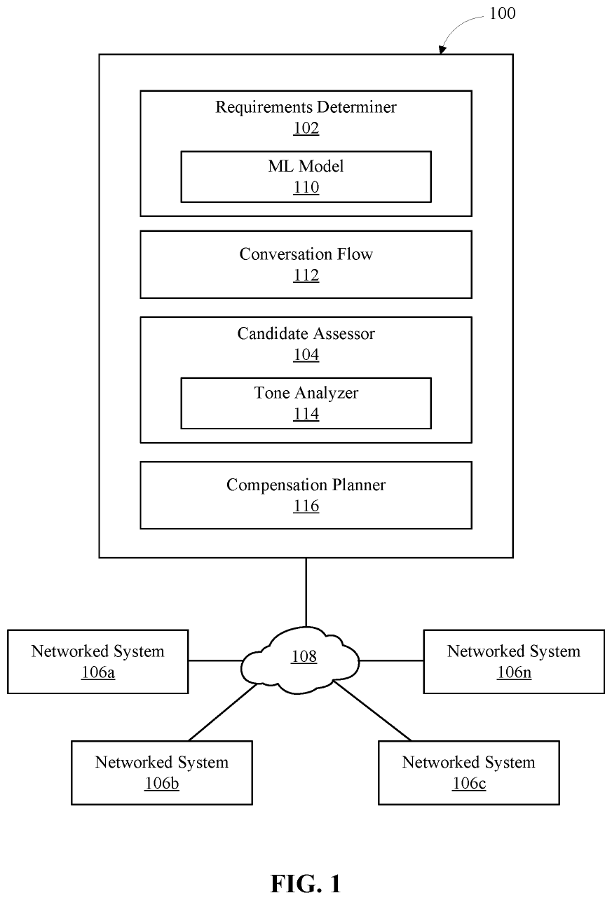

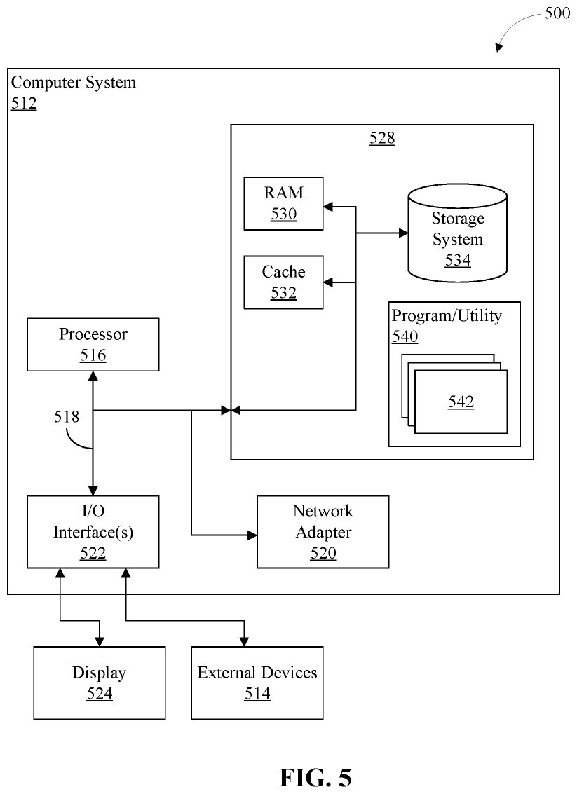

FIG. 1 depicts system 100, which is an example embodiment of a system for determining the requirements of a job and assessing one or more candidates for the job. System 100 illustratively includes requirements determiner 102 and candidate assessor 104. Requirements determiner 102 and candidate assessor 104, in certain embodiments, can be implemented in computer system-executable instructions (e.g., one or more program modules) that are executable on a processor such as processor 516 of computer system 512 described with reference to FIG. 5. Accordingly, in one or more embodiments, system 100 can be implemented in computer-system instructions executable on a computer, a server (e.g., cloud-based server) or other type of computer system. In other embodiments, system 100 can be implemented in hardwired circuitry or in a combination of hardwired circuitry and computer system-executable instructions.

System 100 can communicatively couple with networked systems 106a, 106b, 106c, and 106n via communications network 108. Networked systems 106a, 106b, 106c, and 106n can include data processing systems (including subsystems of larger systems) and/or databases, as described below. System 100 can communicatively link via one or more communications networks to any number of networked systems, as also described below.

Communications network 108 can provide communication links between various devices as well as data processing systems and databases. The communication links can include connections, such as wired communication links, wireless communication links, or fiber optic cables, and can be implemented as, or include, one or more (or any combination of) different communication technologies such as a Wide Area Network (WAN), a Local Area Network (LAN), a wireless network (e.g., a wireless WAN and/or a wireless LAN), a mobile or cellular network, a Virtual Private Network (VPN), the Internet, a Public Switched Telephone Network (PSTN), and so forth. Devices capable of coupling to communications network 108 via wired and/or wireless communication links can include personal computers, portable computing or communication devices, network computers, tablet computers, mobile phones, or the like.

As defined herein, the term “communication link” means a mode of communication using one or more electronic devices. A communication link is associated with a specific format and/or communication protocol for sending messages. For example, using a specific format and/or communication protocol, an electronic device can send a message to another electronic device as a text message, an email, a video call, a voice call, and/or a post to a social networking system. A communication link for exchanging text messages is considered a distinct communication link. Likewise, a communication link for exchanging emails is a distinct communication, as is a communication link for video calls, as is a communication link for voice calls. So, too, a communication link used for posting to social networking systems is considered a distinct communication link. Thus, each type of communication link corresponding to a different type or mode of communication is considered a distinct communication link.

Operatively, system 100 can determine different requirements that a candidate should possess for performing a specific job and can generate a corresponding set of job requirements by searching networked systems 106a-106n. System 100 can extract data from networked systems 106a-106n based on comparing the data contained in the networked systems to certain specifications, the specifications determined from on one or more user inputs. The set of job requirements can be dynamically refined in response to a sequence of user inputs.

User input to system 100 can be a natural language statement or expression (e.g., sentence or phrase). The natural language input can express an attribute or a characteristic that a job candidate should possess. An attribute or characteristic can be expressed by the user in broad, general, or even vague terms. The attribute or characteristic also can be expressed in comparative terms, such as terms comparing a preferred candidate to a known individual (e.g., current or former employee) or a future job to a past job or project. For example, the natural language input can broadly state, “we need a candidate like Ms. Smith” or “find someone like Mr. Jones, who worked on project X last year.” Requirements determiner 102 can convert the natural language input into a command to search networked systems 106a-106n, and to extract data therefrom, data with which requirements determiner 102 identifies the specific requirement or requirements that a job candidate should possess.

Formally, in terms of the underlying logic, requirements determiner 102 implements a function f: S→P that maps a statement s∈S to procedure p∈P, where S is an electronically stored set of known statements that, based on an association rule (function), map to a set of procedures, P. Each procedure, p, comprises a set of computer system-executable instructions (e.g., one or more program modules) that search one or more networked systems (including subsystems) and/or databases and extract therefrom data that requirements determiner 102 uses in identifying job candidate requirements. Requirements determiner 102 invokes a procedure, p, by correctly recognizing the rule-associated statement, s, from the user's natural language input.

Each statement, s, can invoke a corresponding procedure whose parameters are supplied by the user's natural language input. For example, with respect to the natural language input “we need a person like Ms. Smith” or “find someone like Mr. Jones, who worked on project X,” the procedure in both instances is identify and retrieve data, and the parameters are, in the first instance, data related to Ms. Smith and, in the second, data pertaining to Mr. Jones and Project X. In each instance, requirements determiner 102 responds by invoking a procedure that searches networked systems 106a-106n and extracts therefrom data specified by the particular parameters (e.g., employee or other individual data, job or project data).

Requirements determiner 102 can be trained to recognize natural language input using machine learning applied to a training set of correctly labeled examples of user inputs. For example, a machine learning (ML) model 110 (e.g., deep neural network or other classification model) can be constructed to classify user input (sentences or phrases in which each word or character represents a single dimension) using a training set of correctly labeled examples of user input. ML model 110 can be iteratively adjusted through repeated application to the training set until the model is able to classify a test set of example user inputs with an acceptable level of accuracy. Moreover, the accuracy of ML model 110 can be improved with usage over time as the model is applied to an ever-greater number of user inputs which can serve as examples to refine the model.

Requirements determiner 102 can identify keywords within the user input to invoke the correct procedure (learned through machine learning) in response to the user input. A user's natural language input can be broken down into keywords by requirements determiner 102 using natural language processing (NLP). NLP can include parsing the natural language input and performing semantic analysis, which can involve extraction of context-independent aspects of a sentence's or phrase's meaning, including entities, named entities, the semantic roles of entities contained in the processed language input, as well as quantification information, such as cardinality, iteration, and dependency.

In one embodiment, the NLP of requirements determiner 102 analyzes natural language input (text) using lemmatization, a natural language processing technique that performs morphological analysis to identify the lemmas of distinct words in the natural language input. A lemma is the base or dictionary form of a word. For example, implementing a lemmatization, NLP by requirements determiner 102 treats a word such as “saw” as either “see” or “saw” depending on whether the word is used in the document as a verb or a noun, which can be determined using parts-of-speech tagging.

In another embodiment, the NLP of requirements determiner 102 uses a stemming procedure to reduce inflectional forms and derivationally related forms of words in the text of current and archived natural language input. Stemming typically requires less information than lemmatizing (which relies on a vocabulary and morphological analysis to lemmatize words), but is a less refined, more heuristic process that identifies the roots of words by eliminating word endings or derivational affixes of the words. The NLP by requirements determiner 102, in various embodiments, can implement different stemming algorithms, such as the Porter stemmer (which consists of five, sequentially applied phases of word reductions), Lovin stemmer, or Paice stemmer.

In response to user input “we need a candidate like Ms. Smith,” for example, the procedure invoked by requirements determiner 102 is a search of networked systems 106a-106n, which can include a human resources information system (HRIS) and/or human resources management system (HRMS) of the organization for which Ms. Smith currently or formerly worked. The procedure can extract from networked systems 106a-106n data that includes, for example, projects on which Ms. Smith worked, Ms. Smith's education, and any certifications she may hold, as well as assessments of her job performance, creativeness, leadership skills, personality, ability to interact well with colleagues and/or clients, and various other data that is either recorded or contained in stored documents (e.g., employee evaluations, personality assessments, work histories). Based on the data, requirements determiner 102 can construct a set of requirements for a candidate comparable to Ms. Smith. Ms. Smith sets the standard for requirements determiner 102 and, accordingly, a candidate should have a similar level of education and work experience, comparable leadership skills, similar personality, a similar ability to interact with colleagues and clients, and exhibit a comparable level of creativity.

Networked systems 106a-106n can include not only networked systems like HRIS or HRMS networked systems, but various other publicly accessible networked systems. Such networked systems can include, for example, social networking sites and sites maintained by professional organizations, both of which exemplify networked systems that can provide biographical and historical data on an individual whose attributes (e.g., education, experience, personality, skills) can define a preferred candidate for constructing a set of job requirements. Requirements determiner 102 can dynamically refine a set of job requirements by searching and retrieving additional data from these and other networked systems. For example, in response to a natural language input such as “the candidate will work in country A,” requirements determiner 102 can invoke a procedure that searches a commercial or governmental Web site for information on the laws concerning employment in Country B and return data related to the requirements (e.g., visa requirements, work permits). Similarly, in response to a natural language input such as “the candidate needs to practice law in country C,” for example, requirements determiner 102 can invoke a procedure to search a professional organization Website and return data on the requirements for practicing law in country C.

Given the scope of searches performed by requirements determiner 102, not all data extracted from networked systems 106a-106n is necessarily relevant for constructing a specific set of job requirements. Accordingly, requirements determiner 102 can invoke a supplemental procedure to sort out non-relevant data. In response to user input that specifies both job features and candidate attributes, for example, requirements determiner 102 invokes a procedure that maps the job features to specific candidate attributes and discards attributes that do not correspond to a specific job feature. For example, requirements determiner 102 responds to the natural language input “find someone like Mr. Jones, who worked on project X,” by invoking a procedure that encompasses two parameters, Mr. Jones' attributes and specific features of project X. The procedure, as described, searches subsystems (e.g., HRIS and/or HRMS) and/or databases of an enterprise for which Mr. Jones currently works, or worked in the past (as well as other publicly accessible networked systems that may contain data describing Mr. Jones' attributes), and extracts data such as Mr. Jones' education, experience, personality traits, work history, and the like. The procedure also searches subsystems and/or databases for data relating to project X (e.g., database of the department responsible for project X), and extracts data related to the project. Pertinent project data can include, for example, the type of work performed (e.g., design of a system, systems) and the expertise applied to the work (e.g., systems programming). Not all data related to Mr. Jones, however, is necessarily relevant with respect to project X.

Requirements determiner 102 discards the irrelevant data. For example, the fact that Mr. Jones is fluent in German is not significant if project X were undertaken in France. On the assumption (based on the natural language input) that the set of job requirements constructed by requirements determiner 102 applies to a project like project X, and thus does not involve work in Germany, requirements determiner 102 does not include German language skills in constructing a set of job requirements.

In constructing a set of job requirements, requirements determiner 102 can weight individual job requirements according to various criteria. The process of weighting the job requirements, as discussed below, can be applied in ranking job candidates once a complete set of job requirements is constructed. Requirements determiner 102 can use various weighting formulas applied to a diverse array of data extracted from networked systems 106a-106n. A weighting framework can leverage publicly available data and/or intra-organizational data. For example, professionals in a certain field (e.g., IT) may hold different certifications issued by different organizations. Requirements determiner 102 can access various professional Websites, as well as other networked systems, that provide relevant statistics to find which certifications are held and how widely by professionals in the field. Based on the assumption that more widely held certifications are correspondingly more desirable, requirements determiner 102 can weight a certification requirement based on the relative percentage of professionals holding a specific certification. For example, if 67 percent of professionals hold certification A and 33 percent hold certification B, then a candidate's satisfaction of the certification requirement can be accorded twice the weight if the candidate holds certification A rather than certification B. This is but one example of a weighting scheme, and in other embodiments, requirements determiner 102 can apply various other weighting schemes.

In other instances, requirements determiner 102 can leverage data held within a specific enterprise or organization to weight various job requirements. Enterprise-specific data, for example, can be used to relate job requirements to specific projects. For example, with respect to certain skills (e.g., programming), requirements determiner 102 can canvas an enterprise's networked systems to determine which individuals on which projects had which skills. Requirements determiner 102 can weight a skills requirement accordingly. For example, if 80 percent of employees on successful projects were proficient in Python versus 20 percent who were proficient in another programming language, requirements determiner 102 can weight a programming requirement four times greater for a candidate proficient in Python versus ones who are proficient in another programming language. The same methodology can be applied with respect to other job requirements using data acquired from various networked systems 106a-106n, both data internal to the organization and open-source data from publicly accessible source.

Optionally, system 100 can include conversation flow 112 to provide an interactive, conversational framework for interaction between system 100 and a system user. Statements, s, and corresponding procedures, p, form pairs that can be created and stored using different data structures. One data structure that facilitates a conversational framework is a tree structure. Each node of the tree structure can represent a unique procedure, p, that responds to the user's natural language input, s. Statement-response pairs can be clustered based on similarity determined using machine learning. For example, statement-response pairs can be clustered using unsupervised learning, such as the k-nearest neighbor algorithm.

Conversation flow 112 can present appropriately grouped responses to the user's natural language input in a specific order. In one embodiment, a glossary and a naming convention can be used by conversation flow 112 to keep track of statements, s, and response procedures, p (e.g., each statement-response pair can be given a unique ID). Conversation flow 112 can traverse the tree from top to bottom, reviewing branches sequentially to determine whether a response is applicable. The conversation flow can end when terminated by user input or the system is unable to identify any data.

For example, in response to a user input “we need a candidate who can work in country X” conversation flow 112 can follow a response listing specific requirements (e.g., passport, visa, work permit) with a prompt to the user, “will the individual need to drive to multiple locations in country X?”. If the user responds affirmatively, requirements determiner 102 can invoke a process to search an appropriate government database among networked systems 106a-106n to extract data indicating whether an individual holding an international driver's license is permitted to drive in country X Requirements determiner 102 can include in a set of job requirements a specific requirement that a candidate have an international driver's license.

In another example, requirements determiner 102 can respond to a user input “I need someone in the company to work on project Y” by searching one or more databases among networked systems 106a-106n relating to project Y (e.g., electronic records of the department that was responsible for the project) and extracting data to determine what types of skill, experience, or the like a candidate would need to work on a similar project. Conversation flow 112 can follow with a prompt “what role will the individual have on the project?”. If the user responds by indicating that the role will be as team leader, for example, requirements determiner 102 can add to a set of job requirements the specific requirement of “leadership capabilities.” When one or more candidates is assessed, candidate assessor 104, can rank the candidate or candidates using data (e.g., culled from personality profile stored on an HRIS or HRMS) indicating leadership capabilities or lack thereof.

Relatedly, within a specific organization, conversation flow 112 can ask, “which other team members are already selected or are being considered?”. If the user responds by listing one or more names, requirements determiner 102 can automatically add to a set of job requirements the requirement that a candidate be personally compatible with the listed individual or individuals. As described below, data extracted from work histories of the individuals within the organization can be used by candidate assessor 104 to determine a candidate's potential for conflict with any team member already selected or being considered.

Candidate assessor 104, more generally, ranks one or more job candidates based on comparing attributes of the job candidate to corresponding job requirements contained in the set of job requirements generated by requirements determiner 102. The ranking generated by candidate assessor 104 can be an absolute, a relative, or a mixed ranking. Candidate assessor 104 can determine an absolute ranking based on the number of requirements in the constructed set of job requirements that a candidate satisfies. Candidate assessor 104 can use a threshold set by the user to determine whether the number of requirements met by the candidate meets or exceeds the threshold, thereby prompting selection of the candidate or at least the candidate's addition to a pool of possible candidates.

As described above, in some embodiments requirements determiner 102 can weight one or more requirements among the set of job requirements. Candidate assessor 104, accordingly, can determine whether a candidate that otherwise satisfies a requirement does so when a candidate's attribute, as applied to a corresponding requirement, is weighted. For example, candidate assessor 104 can accept a certification (e.g., IT certification) requirement that is weighted by requirements determiner 102, as described above, as being met by a candidate only if the certification held by the candidate meets or exceeds the weighted certification requirement. In the case of the IT certification, for example, a certification that could be obtained from one of three different organizations might be weighted by a company as one, two, or three depending on the organization that granted the certification, three being the most preferred certification and one being the least preferred. If a weighting threshold of two is set, then a candidate would need to be certified by the highest or next-highest ranked organization to satisfy the company's job requirement for being IT certified.

A relative ranking is based on comparing a pool of job candidates to one another. Candidate assessor 104, using one method, can sum the number of requirements met by each candidate and rank the candidates based on the respective sums. The sums can reflect the weights applied to each requirement by requirements determiner 102, as described above, in which event a higher-ranked job candidate would not necessarily meet more requirements than a lower-ranked job candidate, but rather, have a higher score due to meeting requirements weighted sufficiently high. In a mixed ranking, candidate assessor 104 can initially cull from a pool of candidates those candidates that meet or exceed an absolute threshold (e.g., without weighting). Only those candidates that meet or exceed the absolute threshold are ranked by candidate assessor 104, which can apply a relative ranking method (e.g., using weights) to the candidates that, in fact, do meet or exceed the absolute threshold.

Optionally, candidate assessor 104 can include tone analyzer 114, which can be used in conjunction with a candidate interviewing process to assess a candidate's tone or emotion. Tone analyzer 114 can analyze the job candidate's written and verbal utterances using linguistic analysis to determine the candidate's tone (e.g., frustrated, fearful, sad, satisfied, excited, polite, impolite, sympathetic, angry, analytical) at the sentence level. A machine learning model can train tone analyzer 114 to predict tones based on several categories of features, including n-gram features, lexical features from different dictionaries, punctuation, and second-person references. The machine learning model, in one embodiment, can comprise a Support Vector Machine (SVM).

To analyze verbal utterances, tone analyzer 114 can incorporate speech-to-text technology. Tone analyzer 114, using speech-to-text technology, can analyze the job candidate's emotion based on speech output, either in real-time or based on recorded speech. Accordingly, by coupling system 100 with a voice response system, tone analyzer 114 can perform tone analysis on the job candidate's voice utterances.

An interview of a job candidate can be conducted in person, by video conferencing, over a mobile or cellular network, by telephone, or through written exchanges over a data communications network (e.g., email). Tone analyzer 114 can analyze the job candidate's responses (written or textual renderings of verbal responses) to questions posed during the interview. Conversations with the job candidate on general and/or specific topics can also be analyzed by tone analyzer 114, as can verbal interactions during simulated situations. The interview can include requesting the candidate engage in simulated tasks that correspond to tasks encountered in real-world situations related to a specific job. In one embodiment, system 100 can compare the tone and/or emotions of the job candidate to those of current or former employees who previously engaged in the same or a similar interview process or participated in an identical or similar job simulation. Analysis of a job candidate's tone can be an adjunct to, or an alternative for, other methodologies applied by candidate assessor 104 in ranking a job candidate.

In one embodiment related to multi-stage interviewing of a job candidate, candidate assessor 104 can rank a job candidate based, at least in part, on comparing the job candidate's responses to questions presented as a set of multi-tiered questionnaires to another individual's responses to questions presented in the same or a similar set of multi-tiered questionnaires. The questionnaires can be used to comparatively assess the job candidate on multiple dimensions. For example, a first-tier questionnaire can pertain to the job candidate's level of skill (e.g., coding), followed by a second-tier questionnaire related to personality traits, followed by a third-tier questionnaire assessing communication skills of the job candidate. Each questionnaire can be scored by candidate assessor 104, which also can set a threshold at each tier such that the job candidate only progresses to the next tier by successfully completing a current one by scoring at or above the threshold. The thresholds can be determined by candidate assessor 104 based on the other individual's (e.g., current or former employee) responses to questions presented in the same or a similar set of multi-tiered questionnaires.

The other individual can be selected by candidate assessor 104 in response to user input such as “we need a candidate like Ms. Smith” or “find someone like Mr. Jones, who worked on project X last year.” In response to the user input, candidate assessor 104 can search networked system 106a-106n, which can include, for example, an organization's HRIS and/or FIRMS, and extract therefrom data for Ms. Smith or Mr. Jones. The data can include Ms. Smith's or Mr. Jones' scores on the same or similar questionnaires. Moreover, in response to user input like “we need a candidate like Ms. Smith” or “find someone like Mr. Jones,” candidate assessor 104 can construct a set of multi-tiered questionnaires to present to a job candidate so that the questionnaires mirror those previously presented to Ms. Smith or Mr. Jones. By assessing the job candidate on the same or a similar basis as Ms. Smith or Mr. Jones, candidate assessor 104 is more likely to find a candidate that is indeed like Ms. Smith or Mr. Jones.

As described above, requirements determiner 102, in dynamically creating a set of job requirements, can prompt the user to specify whether a job candidate is being considered for a role on a multi-member team. If so, requirements determiner 102 can generate a requirement that the job candidate evince, based on available data, the personality and personal skills to function well within the team. Accordingly, candidate assessor 104 can retrieve data related to the job candidate's personality and personal (e.g., based on personality assessments) for ranking the job candidate. Moreover, in one embodiment, if the team members are part of the same organization, candidate assessor 104 can retrieve pertinent data on the other members of the team. For example, candidate assessor can retrieve personal files and employee evaluations on each of the individuals to determine whether there were past conflicts among an of the individuals.

System 100 optionally includes compensation planner 116. Compensation planner 116 can be invoked in response to a user request to construct a set of job requirements for an upcoming job role or position that must be filled. Compensation planner 116 can search and extract data from networked systems 106a-106n, which can include subsystems and databases containing compensation data relating to an organization's current and former employees. Compensation planner 116 can use data related to current and former employees who have filled a similar job role or position as the one upcoming. Compensation planner 116 can search for and extract data from various networked systems, including an organization's or enterprise's own, as well ones providing publicly accessible data from non-affiliated organizations (e.g., Websites that contain salary or survey data regarding jobs in various fields).

Compensation planner 116 can include data on geographically based pay scales, living conditions in and around the site of the upcoming job, and other data that would likely be important to a job candidate. Compensation planner 116 can analyze data related to intangible benefits (e.g., opportunity for a new employee or recent graduate to gain experience working with experts in a certain field) as well as tangible benefits. Compensation planner 116 can aggregate the data and perform a statistical analysis (e.g., regression analysis) to rank compensation plans according to a determinable likelihood of incentivizing a job candidate to accept a job offer.

Compensation planner 116, in some embodiments, can generate a stand-alone compensation package tailored to a specific individual or type of individual based on the attributes of the individual or individuals as assessed by candidate assessor. In other embodiments, compensation planner can provide compensation data to candidate assessor 104 for ranking a job candidate. Based on the compensation data, candidate assessor 104 can contrast the job candidate's attributes (possibly weighted, as described above) with the expected cost to an organization or enterprise of offering the compensation that would likely incentivize the job candidate to accept the job offer. Accordingly, candidate assessor 104 can determine if a candidate otherwise superior in credentials or attributes to another candidate is simply too costly to the firm, prompting candidate assessor 104 to possibly rank the candidate lower than the other candidate.

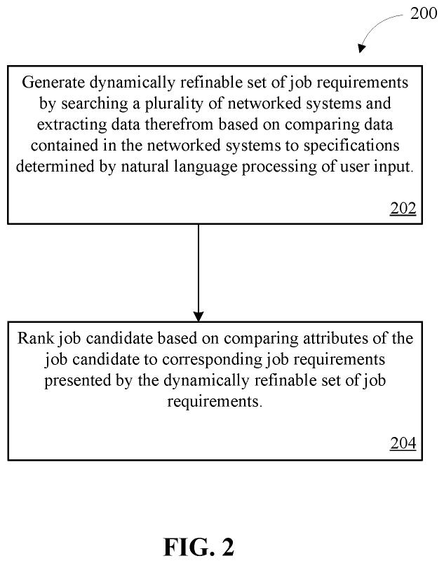

FIG. 2 is a flowchart of method 200 for determining job requirements and assessing job candidates according to one embodiment. Method 200 can be performed by a system the same as or similar to the systems described in reference to FIG. 1. The system at block 202 can generate a set of job requirements in response to user input. The user input can be a natural language input (entered as text or converted to text by a speech-to-text engine). The system can use natural language processing to convert the user input into a computer-usable form. The set of job requirements generated by the system can be dynamically refined in response to a sequence of natural language user inputs.

The system can be trained to recognize natural language input using machine learning (e.g., deep learning neural networks) and, based on a classification model, respond to the input by invoking a corresponding procedure to search networked systems and extract therefrom the data used to dynamically generate a set of job requirements. At block 204, the system can rank a job candidate by comparing attributes of the job candidate to corresponding job requirements contained in the dynamically refinable set of job requirements generated at block 202.

The system in some embodiments can weight one or more of the attributes of the job candidate and corresponding job requirements contained in the dynamically refinable set of job requirements. The weights can be based on a relevancy determination of each of the job requirements. The system can determine a relevancy based, for example, on statistical data retrieved by the system from organization- or enterprise-specific networked systems (e.g., human resource data, employee evaluations, project analyses) or publicly accessible network systems (e.g., professional organization Websites). A relevancy determination can apply to credentials, skills, and other factors that distinguish certain attributes from others when viewed as a distinct class or group (e.g., preferred certifications relative to other certifications, usefulness of programming skills in one computer language versus another).

In other embodiments, the system can rank a job candidate by performing tone analysis to determine a tone of the job candidate during an interview phase. Tone analysis can determine the candidate's tone (e.g., frustrated, fearful, sad, satisfied, excited, polite, impolite, sympathetic, angry, analytical) during an in-person interview or based on a recording of an interview conducted in person, by video conferencing, over a mobile or cellular network, by telephone, or through written exchanges over a data communications network. The interview can include requesting the candidate engage in simulated tasks that correspond to tasks encountered in real-world situations related to a specific job. In one embodiment, the system can compare the job candidate's tone and/or emotions to those of a current or former employee who previously engaged in the same or a similar interview process or participated in an identical or similar job simulation.

The system in still other embodiments can rank a job candidate by constructing a compensation package having a determinable likelihood of incentivizing the job candidate to accept a job offer. The system can construct the compensation package by aggregating data from a variety of networked systems (e.g., government Websites that provide data on labor trends, private organizations that track salary data), including an organization's or enterprise's own human resources system, and performing one or more statistical analyses (e.g., regression analysis) in order to rank compensation plans according to a determinable likelihood of incentivizing a job candidate to accept a job offer. The system can rank a job candidate based on juxtaposition of the job candidate's attributes (possible weighted) with the expected cost of offering a compensation that would likely be needed to incentivize the job candidate to accept a job offer.

In yet other embodiments, the system can rank a job candidate based, at least in part, on a predicted likelihood that the job candidate, as a team member of a multi-member team, would be compatible with other team members. The prediction can be based on data (e.g., employee records, employee evaluations) obtained by the system from, for example, an organization's HRIS or HRMS. When a team within the enterprise or organization is being formulated, the system can determine who is, or possibly will be, members and can evaluate the data to determine, based on historical events, whether the individuals can be expected to work well together.

The system, in certain embodiments, can rank multiple candidates based on attributes identified by the system from analysing attributes of members of a specific team within or known to the organization or of individuals who, in different roles, worked jointly on a specific project for the organization. The identified attributes, which can correspond to individuals performing specific roles, can be used by the system to construct a team profile. In forming a team that corresponds to the team profile with respect to a referenced project or role within the organization, the system can rank individual candidates based on a comparison of each candidate's attributes with those of individuals performing in specific roles on a team within or known to the organization or of individuals who worked, in different roles, jointly on a specific project for the organization. A team that matches the team profile can be built by selecting candidates based on the system-determined rankings.

For example, in response to user input such as “We need a Team like ABC who worked on project X last year for our upcoming Project Y,” the system would identify attributes associated with different contributors to the team, who served in different roles (e.g., frontend programmers, backend programmers, product managers, technical document writers, architects, designers, and the like) on project X. The system, based on the operations described above, can consider attributes of each contributor and determine a best composition of a team matching the ABC team's profile.

In still other embodiments, the system can rank a job candidate based additionally on comparing the job candidate's responses to questions presented in a set of multi-tiered questionnaires with another individual's responses to similar questions. The system can use the questionnaires to comparatively assess the job candidate on multiple dimensions. Each questionnaire can be scored by the system, which also can set a threshold at each tier such that the job candidate only progresses to the next tier by successfully completing a current one by scoring at or above the threshold. The system can determine the thresholds based on the other individual's responses to questions presented in the same or a similar set of multi-tiered questionnaires.

Embodiments of the present invention have been described in the context of various computing environments. The embodiments are capable of being implemented in conjunction with any other type of computing environment now known or later developed. One such computing environment, for example, is a cloud computing environment, though it is understood the teachings recited herein are not limited to a cloud computing environment.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

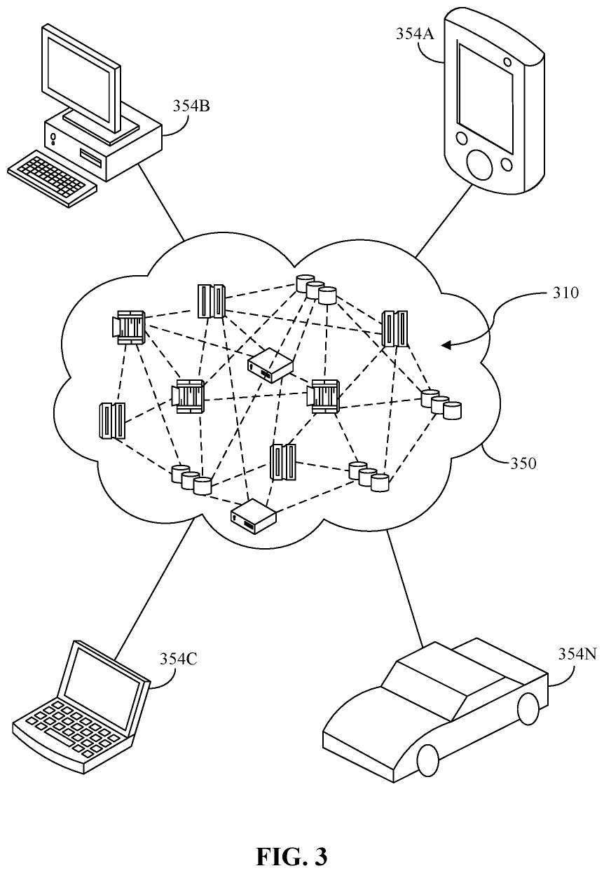

Referring now to FIG. 3, illustrative cloud computing environment 350 is depicted. As shown, cloud computing environment 350 includes one or more cloud computing nodes 310 with which local computing devices used by cloud consumers, such as, for example, personal digital assistant (PDA) or cellular telephone 354A, desktop computer 354B, laptop computer 354C, and/or automobile computer system 354N may communicate. Computing nodes 310 may communicate with one another. They may be grouped (not shown) physically or virtually, in one or more networks, such as Private, Community, Public, or Hybrid clouds as described hereinabove, or a combination thereof. This allows cloud computing environment 350 to offer infrastructure, platforms and/or software as services for which a cloud consumer does not need to maintain resources on a local computing device. It is understood that the types of computing devices 354A-N shown in FIG. 3 are intended to be illustrative only and that computing nodes 310 and cloud computing environment 350 can communicate with any type of computerized device over any type of network and/or network addressable connection (e.g., using a web browser).

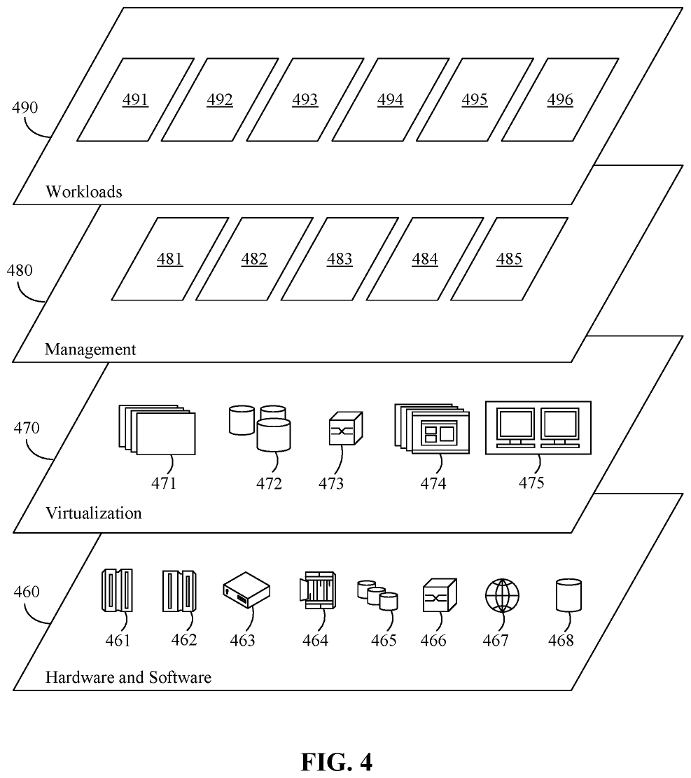

Referring now to FIG. 4, a set of functional abstraction layers provided by cloud computing environment 350 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 460 includes hardware and software components. Examples of hardware components include: mainframes 461; RISC (Reduced Instruction Set Computer) architecture based servers 462; servers 463; blade servers 464; storage devices 465; and networks and networking components 466. In some embodiments, software components include network application server software 467 and database software 468.

Virtualization layer 470 provides an abstraction layer from which the following examples of virtual entities may be provided: virtual servers 471; virtual storage 472; virtual networks 473, including virtual private networks; virtual applications and operating systems 474; and virtual clients 475.

In one example, management layer 480 may provide the functions described below. Resource provisioning 481 provides dynamic procurement of computing resources and other resources that are utilized to perform tasks within the cloud computing environment. Metering and Pricing 482 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 483 provides access to the cloud computing environment for consumers and system administrators. Service level management 484 provides cloud computing resource allocation and management such that required service levels are met. Service Level Agreement (SLA) planning and fulfillment 485 provides pre-arrangement for, and procurement of, cloud computing resources for which a future requirement is anticipated in accordance with an SLA. Workloads layer 490 provides examples of functionality for which the cloud computing environment may be utilized. Examples of workloads and functions which may be provided from this layer include: mapping and navigation 491; software development and lifecycle management 492; virtual classroom education delivery 493; data analytics processing 494; transaction processing 495; and job requirements determination and candidate assessment 496.

FIG. 5 illustrates a schematic of an example computing node, computing node 500, for implementing various embodiments of the present disclosure. In one or more embodiments, computing node 500 illustrates a suitable server and/or cloud computing node. Computing node 500 is not intended to suggest any limitation as to the scope of use or functionality of embodiments of the invention described herein. Computing node 500 is capable of performing any of the functionality described within this disclosure.

Computing node 500 includes a computer system 512, which is operational with numerous other general-purpose or special-purpose computing system environments or configurations. Examples of well-known computing systems, environments, and/or configurations that may be suitable for use with computer system 512 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 512 may be described in the general context of computer system-executable instructions, such as program modules, being executed by a computer system. Generally, program modules may include routines, programs, objects, components, logic, data structures, and so on that perform particular tasks or implement particular abstract data types. Computer system 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system 512 is shown in the form of a general-purpose computing device. The components of computer system 512 may include, but are not limited to, one or more processors 516, a memory 528, and a bus 518 that couples various system components including memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, and PCI Express (PCIe) bus.

Computer system 512 typically includes a variety of computer system readable media. Such media may be any available media that is accessible by computer system 512, and may include both volatile and non-volatile media, removable and non-removable media.

Memory 528 may include computer system readable media in the form of volatile memory, such as random-access memory (RAM) 530 and/or cache memory 532. Computer system 512 may further include other removable/non-removable, volatile/non-volatile computer system storage media. By way of example, storage system 534 can be provided for reading from and writing to a non-removable, non-volatile magnetic media and/or solid-state drive(s) (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein. For example, one or more of the program modules may include system 496 or portions thereof.

Program/utility 540 is executable by processor 516. Program/utility 540 and any data items used, generated, and/or operated upon by computer system 512 are functional data structures that impart functionality when employed by computer system 512. As defined within this disclosure, a “data structure” is a physical implementation of a data model's organization of data within a physical memory. As such, a data structure is formed of specific electrical or magnetic structural elements in a memory. A data structure imposes physical organization on the data stored in the memory as used by an application program executed using a processor.

Computer system 512 may also communicate with one or more external devices 514 such as a keyboard, a pointing device, a display 524, etc.; one or more devices that enable a user to interact with computer system 512; and/or any devices (e.g., network card, modem, etc.) that enable computer system 512 to communicate with one or more other computing devices. Such communication can occur via input/output (I/O) interfaces 522. Still yet, computer system 512 can communicate with one or more networks such as a local area network (LAN), a general wide area network (WAN), and/or a public network (e.g., the Internet) via network adapter 520. As depicted, network adapter 520 communicates with the other components of computer system 512 via bus 518. It should be understood that although not shown, other hardware and/or software components could be used in conjunction with computer system 512. Examples include but are not limited to microcode, device drivers, redundant processing units, external disk drive arrays, RAID systems, tape drives, and data archival storage systems, etc.

While computing node 500 is used to illustrate an example of a cloud computing node, it should be appreciated that a computer system using an architecture the same as or similar to that described in connection with FIG. 5 may be used in a non-cloud computing implementation to perform the various operations described herein. In this regard, the example embodiments described herein are not intended to be limited to a cloud computing environment. Computing node 500 is an example of a data processing system. As defined herein, the term “data processing system” means one or more hardware systems configured to process data, each hardware system including at least one processor programmed to initiate executable operations and memory.

Computing node 500 may include fewer components than shown or additional components not illustrated in FIG. 5 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, a “user” is a human being.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented solely for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-7. (canceled)

8. A system, comprising:
a processor configured to initiate executable operations including:
generating a dynamically refinable set of job requirements by searching a plurality of networked systems and extracting data therefrom based on comparing data contained in the networked systems to specifications determined by natural language processing of user input; and
ranking a job candidate based on comparing attributes of the job candidate to corresponding job requirements contained in the dynamically refinable set of job requirements.

9. The system of claim 8, wherein
the processor is configured to initiate executable operations further comprising weighting the attributes of the job candidate and the job requirements contained in the dynamically refinable set of job requirements based on a relevancy determination of each of the job requirements.

10. The system of claim 8, wherein
the ranking the job candidate further comprises performing tone analysis to determine a tone of the job candidate during an interview phase.

11. The system of claim 8, wherein
the ranking the job candidate further comprises constructing a compensation package having a determinable likelihood of incentivizing the job candidate to accept a job offer.

12. The system of claim 8, wherein
the ranking the job candidate further comprises predicting a likelihood that the job candidate, as a team member of a multi-member team, is compatible with other team members.

13. The system of claim 8, wherein
the generating the dynamically refinable set of job requirements is based on a machine learning classification model constructed using a training set of correctly labeled examples of user inputs that match at least one of an organization's employees and/or past projects of the organization.

14. A computer program product comprising
a computer readable storage medium having program instructions embodied therewith, the program instructions executable by a processor to cause the processor to initiate executable operations comprising:
generating a dynamically refinable set of job requirements by searching a plurality of networked systems and extracting data therefrom based on comparing data contained in the networked systems to specifications determined by natural language processing of user input; and
ranking a job candidate based on comparing attributes of the job candidate to corresponding job requirements contained in the dynamically refinable set of job requirements.

15. The computer program product of claim 14, wherein
the program instructions are executable by the processor to cause the processor to initiate executable operations further comprising weighting the attributes of the job candidate and the job requirements contained in the dynamically refinable set of job requirements based on a relevancy determination of each of the job requirements.

16. The computer program product of claim 14, wherein
the ranking the job candidate further comprises performing tone analysis to determine a tone of the job candidate during an interview phase.

17. The computer program product of claim 14, wherein
the ranking the job candidate further comprises constructing a compensation package having a determinable likelihood of incentivizing the job candidate to accept a job offer.

18. The computer program product of claim 14, wherein
the ranking the job candidate further comprises predicting a likelihood that the job candidate, as a team member of a multi-member team, is compatible with other team members.

19. The computer program product of claim 14, wherein
the ranking the job candidate comprises ranking the job candidate based additionally on comparing the job candidate's responses to questions presented in a set of multi-tiered questionnaires with another individual's responses to similar questions.

20. The computer program product of claim 14, wherein
the generating the dynamically refinable set of job requirements is based on a machine learning classification model constructed using a training set of correctly labeled examples of user inputs that match at least one of an organization's employees and/or past projects of the organization.
